(19) United States
(12) Patent Application Publication
(10) Pub. No.: US 2024/0248490 A1
(43) Pub. Date: Jul. 25, 2024

(54) PATROL ROUTE DETERMINATION SYSTEM, PATROL ROUTE DETERMINATION METHOD, AND NON-TRANSITORY COMPUTER-READABLE MEDIUM

(71) Applicant: NEC Corporation, Minato-ku, Tokyo (JP)

(72) Inventors: Akira Tsuji, Tokyo (JP); Jiro Abe, Tokyo (JP)

(73) Assignee: NEC Corporation, Minato-ku, Tokyo (JP)

(21) Appl. No.: 18/290,344

(22) PCT Filed: May 20, 2021
(86) PCT No.: PCT/JP2021/019241

§ 371 Date: Nov. 13, 2023

(51) Int. Cl. G05D 1/646; G05D 1/689; G05D 105/80

(52) U.S. Cl. CPC G05D 1/646; G05D 1/689; G05D 2105/89

(57) ABSTRACT

A patrol route determination system according to one aspect of the present disclosure includes: a measurement position information storage unit configured to store information regarding a plurality of pieces of equipment and information regarding measurement positions for the plurality of pieces of equipment in association with each other; a measurement position determination unit configured to determine a measurement position based on information regarding the measurement target, information regarding the measurement device, and the information regarding the measurement position set for each piece of equipment stored in the measurement position information storage unit; and a patrol route determination unit configured to determine a patrol route along which the measurement device autonomously moves in the facility and makes a patrol of the measurement target equipment by using information regarding the measurement position for the measurement target equipment.

### TECHNICAL FIELD

The present invention relates to a patrol route determination system, a patrol route determination method, and a non-transitory computer-readable medium.

### BACKGROUND ART

In recent years, a technology for acquiring three-dimensional data of a measurement target by using a three-dimensional distance sensor such as light detection and ranging (LIDAR) has been developed. In addition, a technology has been developed in which such a three-dimensional distance sensor is mounted on autonomous movement means and makes a patrol, three-dimensional data of a social infrastructure facility is acquired, and equipment in the facility is automatically inspected using the acquired three-dimensional data.

Patent Literature 1 discloses a technology related to an inspection patrol support system capable of efficiently and accurately detecting an abnormal place in a social infrastructure facility. Patent Literature 2 discloses a technology related to a power distribution system map data distribution system that enables workers to quickly and efficiently perform power outage recovery measures and inspection patrol based on the latest power distribution system map.

### CITATION LIST

### Patent Literature

Patent Literature 1: Japanese Unexamined Patent Application Publication No. 2019-9919
Patent Literature 2: Japanese Unexamined Patent Application Publication No. 2004-229456

### SUMMARY OF INVENTION

### Technical Problem

As described in Background Art, a technology has been developed in which a three-dimensional distance sensor such as LIDAR is mounted on autonomous movement means and makes a patrol, three-dimensional data of a social infrastructure facility is acquired, and equipment in the facility is automatically inspected by using the acquired three-dimensional data.

However, since there are a large number of social infrastructure facilities (for example, a power plant or a substation), there is a problem that work of setting a patrol route becomes complicated in a case where a patrol route of a measurement device (autonomous movement means equipped with a three-dimensional distance sensor) is manually set for each of such facilities.

An object of the present disclosure is to provide a patrol route determination system capable of automatically determining a patrol route along which a measurement device makes a patrol and inspects a predetermined facility, a patrol route determination method, and a non-transitory computer-readable medium.

### Solution to Problem

A patrol route determination system according to one aspect of the present disclosure includes: a measurement position information storage unit configured to store information regarding a plurality of pieces of equipment and information regarding a measurement position where three-dimensional data of each of the plurality of pieces of equipment is to be acquired using a measurement device in association with each other; a measurement position determination unit configured to determine a measurement position where three-dimensional data of measurement target equipment is to be acquired using the measurement device based on information regarding the measurement target equipment provided in a predetermined facility, information regarding the measurement device used to measure the measurement target equipment, and the information regarding the measurement position set for each piece of equipment stored in the measurement position information storage unit; and a patrol route determination unit configured to determine a patrol route along which the measurement device autonomously moves in the facility and makes a patrol of the measurement target equipment by using information regarding the measurement position for the measurement target equipment determined by the measurement position determination unit.

A patrol route determination method according to one aspect of the present disclosure includes: acquiring information regarding measurement target equipment provided in a predetermined facility and information regarding a measurement device used to measure the measurement target equipment; acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and determining a patrol route along which the measurement device autonomously moves in the facility and makes a patrol of the measurement target equipment by using information regarding the determined measurement position for the measurement target equipment.

A non-transitory computer-readable medium according to one aspect of the present disclosure is a non-transitory computer-readable medium that stores a program for causing a computer to execute patrol route determination processing including: processing of acquiring information regarding measurement target equipment provided in a predetermined facility and information regarding a measurement device used to measure the measurement target equipment; processing of acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and processing of determining a patrol route along which the measurement device autonomously moves in the facility and makes a patrol of the measurement target equipment by using information regarding the determined measurement position for the measurement target equipment.

### Advantageous Effects of Invention

According to the present disclosure, it is possible to provide the patrol route determination system capable of automatically determining a patrol route along which a measurement device makes a patrol and inspects a predetermined facility, the patrol route determination method, and the non-transitory computer-readable medium.

### BRIEF DESCRIPTION OF DRAWINGS

FIG. 1 is a block diagram illustrating a configuration example of a patrol route determination system according to an example embodiment.

FIG. 2 is a diagram illustrating an example of information regarding a measurement position stored in a measurement position information storage unit.

FIG. 3 is a diagram illustrating an example of measurement target equipment provided in a facility.

FIG. 4 is a diagram for describing measurement position determination processing in the patrol route determination system according to the example embodiment.

FIG. 5 is a diagram for describing another example of the measurement position determination processing in the patrol route determination system according to the example embodiment.

FIG. 6 is a diagram for describing another example of the measurement position determination processing in the patrol route determination system according to the example embodiment.

FIG. 7 is a diagram for describing patrol route determination processing in the patrol route determination system according to the example embodiment.

FIG. 8 is a diagram for describing another example of the patrol route determination processing in the patrol route determination system according to the example embodiment.

FIG. 9 is a flowchart for describing a patrol route determination method according to the example embodiment.

FIG. 10 is a block diagram illustrating a hardware configuration example including the patrol route determination system according to the example embodiment.

### EXAMPLE EMBODIMENT

Hereinafter, example embodiments of the present invention will be described with reference to the drawings.

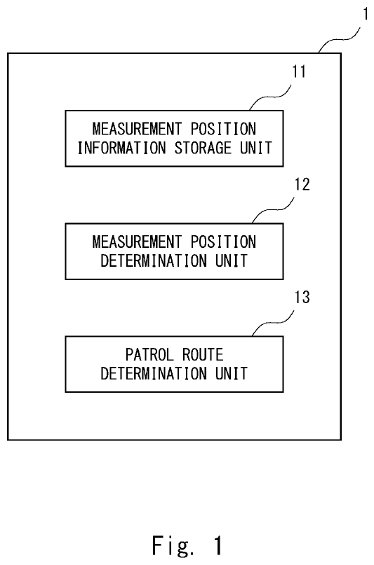

FIG. 1 is a block diagram illustrating a configuration example of a patrol route determination system according to an example embodiment. As illustrated in FIG. 1, a patrol route determination system 1 according to the present example embodiment includes a measurement position information storage unit 11, a measurement position determination unit 12, and a patrol route determination unit 13. The patrol route determination system 1 according to the present example embodiment is a system used to determine a patrol route of a measurement device in a system that causes the measurement device to make a patrol to acquire three-dimensional data of a predetermined facility such as a social infrastructure facility, and automatically inspects equipment in the facility by using the acquired three-dimensional data.

In the present example embodiment, the measurement device is a device in which a three-dimensional distance sensor such as light detection and ranging (LIDAR) is mounted on autonomous movement means. Examples of the measurement device include an autonomously movable vehicle on which LIDAR is mounted, an autonomously movable drone on which LIDAR is mounted, and an autonomously movable robot on which LIDAR is mounted. In the present example embodiment, the measurement device is not limited thereto, and may be any device as long as the measurement device is a device in which a three-dimensional distance sensor is mounted on autonomous movement means.

The measurement position information storage unit 11 stores information regarding a plurality of pieces of equipment and information regarding a measurement position where three-dimensional data of each of the plurality of pieces of equipment is to be acquired using the measurement device in association with each other. Specifically, the measurement position information storage unit 11 stores information regarding a default measurement position (three-dimensional coordinates) for equipment for each type of equipment. When an identifier indicating the type of the equipment (measurement target equipment) is input from the measurement position determination unit 12, the measurement position information storage unit 11 outputs information regarding the measurement position corresponding to the input equipment to the measurement position determination unit 12. In the present example embodiment, when acquiring the three-dimensional data of the measurement target equipment, the measurement device stops at the measurement position and performs the measurement.

The measurement position information storage unit 11 may further store information regarding the type of the equipment and information regarding the size of the equipment in association with each other. In this case, when the identifier indicating the type of the equipment (measurement target equipment) is input from the measurement position determination unit 12, the measurement position information storage unit 11 outputs information regarding the size of the input equipment to the measurement position determination unit 12 together with information regarding the measurement position corresponding to the input equipment. The information regarding the size of the equipment stored in the measurement position information storage unit 11 may be the actual size of the equipment, or may be a value obtained by normalizing one side of the equipment to 1. In addition, the type of the equipment may include the model of the equipment, and the measurement position information storage unit 11 may store the model of equipment and the size of the equipment in association with each other. That is, in a case where the types of the pieces of equipment are the same as each other, but the models of the pieces of equipment are different from each other, the sizes of the pieces of equipment may be different from each other. Therefore, the measurement position for equipment can be determined in detail by managing the model of the equipment.

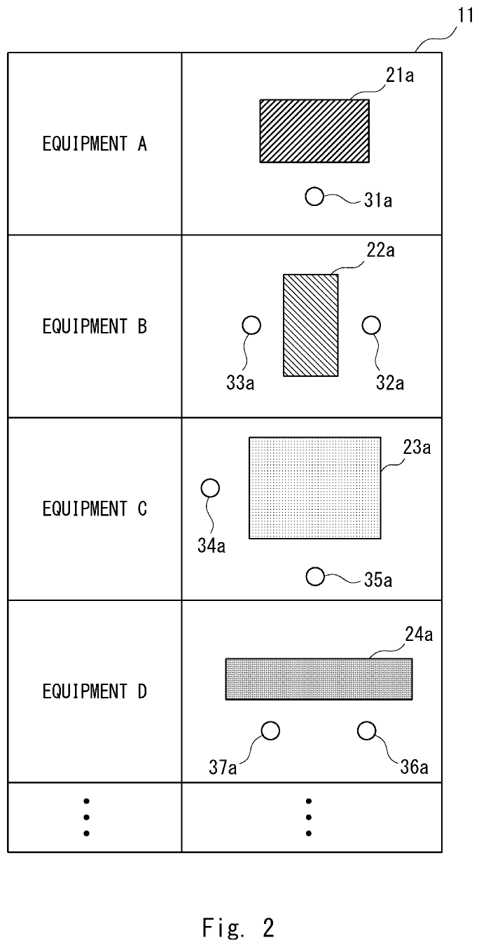

FIG. 2 is a diagram illustrating an example of the information regarding the measurement position stored in the measurement position information storage unit 11. As illustrated in FIG. 2, the measurement position information storage unit 11 stores the information regarding a plurality of pieces of equipment and the information regarding a measurement position where three-dimensional data of each of the plurality of pieces of equipment is to be acquired using the measurement device in association with each other. Specifically, information regarding equipment A (an identifier of the equipment A) and information regarding a measurement position 31a where three-dimensional data of the equipment A (21a) is to be acquired are stored in association with each other. For example, the information regarding the measurement position 31a can be expressed by three-dimensional coordinates with a predetermined reference point of the equipment A (21a) as an origin.

Similarly, the measurement position information storage unit 11 stores information regarding equipment B (an identifier of the equipment B) and information regarding measurement positions 32a and 33a where three-dimensional data of the equipment B (22a) is to be acquired in association with each other. Similarly, the measurement position information storage unit 11 stores information regarding equipment C (an identifier of the equipment C) and information regarding measurement positions 34a and 35a where three-dimensional data of the equipment C (23a) is to be acquired in association with each other. Similarly, the measurement position information storage unit 11 stores information regarding equipment D (an identifier of the equipment D) and information regarding measurement positions 36a and 37a where three-dimensional data of the equipment D (24a) is to be acquired in association with each other.

Here, the measurement position where the three-dimensional data of the equipment is to be acquired is a measurement position suitable for acquiring the three-dimensional data of the equipment. Examples of the suitable measurement position include a position suitable for acquiring three-dimensional data of a place where a component that is likely to fail is provided, a position suitable for acquiring three-dimensional data of a place where many components are provided, and a position where three-dimensional data of the entire equipment can be efficiently acquired.

As illustrated in FIG. 2, the number of measurement positions where the three-dimensional data of each piece of equipment is to be acquired may be one (see the equipment A), or may be plural (see the pieces of equipment B to D). In addition, the measurement position information storage unit 11 may store the information regarding the size of the equipment. That is, information regarding the size (depth×width×height) of each of the pieces of equipment 21a to 24a illustrated in FIG. 2 may be stored.

Next, the measurement position determination unit 12 (see FIG. 1) will be described. The measurement position determination unit 12 determines the measurement position where the three-dimensional data of the measurement target equipment is to be acquired by using the measurement device based on the information regarding the measurement target equipment provided in the predetermined facility, the information regarding the measurement device used to measure the measurement target equipment, and the information regarding the measurement position set for each piece of equipment stored in the measurement position information storage unit 11.

The information regarding the measurement target equipment provided in the facility may include information regarding the type and installation position of the measurement target equipment. In this case, the measurement position determination unit 12 acquires the information regarding the measurement position corresponding to the type of the measurement target equipment from the measurement position information storage unit 11, and determines the measurement position for the measurement target equipment by using the acquired information regarding the measurement position and the acquired information regarding the installation position of the measurement target equipment. Hereinafter, measurement position determination processing in the measurement position determination unit 12 will be specifically described.

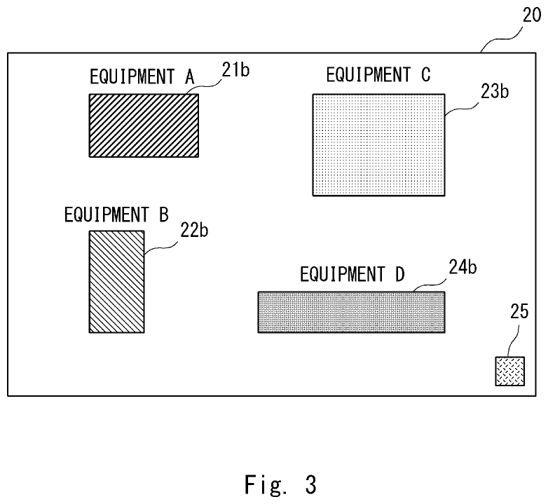

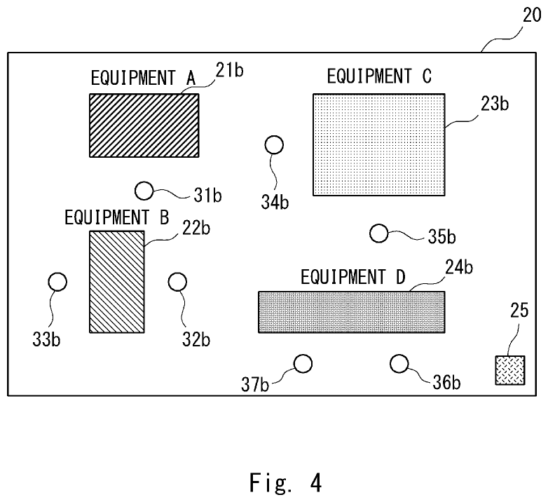

FIG. 3 is a diagram illustrating an example of the measurement target equipment provided in the facility. FIG. 4 is a diagram for describing the measurement position determination processing in the patrol route determination system according to the present example embodiment. As illustrated in FIG. 3, pieces of measurement target equipment A to D (21b to 24b) are provided in a predetermined facility 20. For example, the predetermined facility 20 is a social infrastructure facility such as a power plant or a substation. In a case where the predetermined facility 20 is a substation, the pieces of measurement target equipment 21b to 24b are transformers, insulators, steel structures, lead wires, and the like. In addition, a measurement device 25 is provided in the facility 20. The measurement device 25 stands by at a position illustrated in FIG. 3. The scope of application of the invention according to the present example embodiment is not limited to social infrastructure facilities such as power plants and substations, and can include determination of a patrol route in all other facilities.

The measurement position determination unit 12 acquires information regarding the pieces of measurement target equipment 21b to 24b provided in the facility 20. Specifically, the measurement position determination unit 12 acquires information regarding the types of the pieces of measurement target equipment 21b to 24b provided in the facility 20 and information regarding the installation positions of the pieces of measurement target equipment 21b to 24b in the facility 20. For example, the measurement position determination unit 12 may use, as the information regarding the installation positions, three-dimensional coordinate values of the pieces of measurement target equipment 21b to 24b when an arbitrary reference point in the facility 20 is set as the origin. At this time, the three-dimensional coordinate value of the vertex of a solid (for example, a rectangular parallelepiped) including each of the pieces of measurement target equipment 21b to 24b may be used as the information regarding the installation position. In addition, the measurement position determination unit 12 may acquire information regarding the installation positions of the pieces of measurement target equipment 21b to 24b in the facility 20 by acquiring three-dimensional CAD data (design drawing) of the pieces of measurement target equipment 21b to 24b provided in the facility 20.

In addition, the measurement position determination unit 12 acquires information regarding the measurement device 25 used to measure the pieces of measurement target equipment 21b to 24b. The information regarding the measurement device 25 is information regarding the performance of the measurement device 25, and is, for example, information regarding the measurement range of the measurement device 25, information regarding the resolution of the measurement device 25, information regarding the size of the measurement device 25, or information regarding the measurement time of the measurement device 25. The information regarding the measurement range of the measurement device 25 is information regarding a measurement range of the LIDAR in a horizontal direction and a measurement range of the LIDAR in a vertical direction. The information regarding the resolution of the measurement device 25 is information regarding the resolution of the LIDAR in the horizontal direction and the resolution of the LIDAR in the vertical direction. The information regarding the measurement time of the measurement device 25 is information regarding a time necessary for acquiring three-dimensional data with a predetermined resolution in a predetermined measurement range using the LIDAR.

Then, the measurement position determination unit 12 acquires information regarding measurement positions 31a to 37a for pieces of equipment corresponding to the pieces of measurement target equipment 21b to 24b from the measurement position information storage unit 11 by using the acquired information regarding the pieces of measurement target equipment 21b to 24b (see FIG. 2). Specifically, the measurement position determination unit 12 supplies, to the measurement position information storage unit 11, the acquired information regarding the pieces of measurement target equipment 21b to 24b (for example, identifiers indicating the types of the pieces of measurement target equipment 21b to 24b). The measurement position information storage unit 11 supplies, to the measurement position determination unit 12, the information regarding the measurement positions 31a to 37a for pieces of equipment 21a to 24a corresponding to the pieces of measurement target equipment 21b to 24b supplied from the measurement position determination unit 12. Thereafter, the measurement position determination unit 12 determines measurement positions 31b to 37b (see FIG. 4) where three-dimensional data of the pieces of measurement target equipment 21b to 24b are to be acquired by using the measurement device 25 based on the information regarding the measurement position supplied from the measurement position information storage unit 11 and the information regarding the measurement device 25.

By executing such processing, the measurement position determination unit 12 can determine the measurement positions 31b to 37b for the pieces of measurement target equipment 21b to 24b as illustrated in FIG. 4. For example, in a case where an arbitrary reference point in the facility 20 is set as the origin, the measurement position determination unit 12 can express each of the measurement positions 31b to 37b by using three-dimensional coordinates.

The measurement positions 31a to 37a for the pieces of equipment 21a to 24a stored in the measurement position information storage unit 11 illustrated in FIG. 2 correspond to the measurement positions 31b to 37b for the pieces of measurement target equipment 21b to 24b determined by the measurement position determination unit 12 illustrated in FIG. 4, respectively. In FIG. 2, “a” is added to the reference numerals of the equipment and measurement positions, and in FIG. 4, “b” is added to reference numerals of the measurement target equipment and measurement positions to distinguish them.

In addition, the measurement position determination unit 12 may determine the measurement direction (a direction of the measurement center in the horizontal direction and the vertical direction) of the measurement device 25 at each of the measurement positions 31b to 37b. That is, the measurement position determination unit 12 may determine the measurement direction (control parameter) of the measurement device 25 at each of the measurement positions 31b to 37b by using the information regarding the measurement range of the measurement device 25.

For example, in a case where the measurement range of the measurement device 25 in the horizontal direction is 360 degrees (entire range), the measurement can be performed without determining the measurement direction of the measurement device 25 in the horizontal direction. However, in a case where the measurement range of the measurement device 25 in the horizontal direction is within a predetermined range, it is necessary to determine the measurement direction of the measurement device 25 in the horizontal direction. For example, in a case where the measurement range of the measurement device 25 in the horizontal direction is −180 degrees to +180 degrees, the measurement direction in the horizontal direction may be determined in such a way that the measurement direction of the measurement device 25 (that is, a direction of 0 degrees as the measurement center) is substantially perpendicular to the measurement target equipment. The measurement direction in the vertical direction can be determined in a similar manner.

In addition, the measurement position determination unit 12 may determine a measurement distance, which is a distance between the measurement device 25 and each of the pieces of measurement target equipment 21b to 24b, based on the resolution of measurement data to be acquired and the resolution of the measurement device 25, and determine the measurement positions 31b to 37b for the pieces of measurement target equipment 21b to 24b by further using the determined measurement distance. That is, the smaller the measurement distance of the measurement device 25, the higher the resolution of the measurement data, and the larger the measurement distance of the measurement device 25, the lower the resolution of the measurement data. The measurement position determination unit 12 determines the optimum measurement position of the measurement device 25 based on the resolution of the measurement data to be acquired and the resolution of the measurement device 25. In this case, information regarding the resolution of the measurement data to be acquired (that is, information regarding the required resolution) is supplied to the measurement position determination unit 12 in advance.

In addition, the measurement position determination unit 12 may determine the measurement positions 31b to 37b for the pieces of measurement target equipment 21b to 24b by further using the information regarding the size of the equipment acquired from the measurement position information storage unit 11. In this manner, the measurement position can be determined more accurately by using the information regarding the size of the equipment (the pieces of measurement target equipment 21b to 24b).

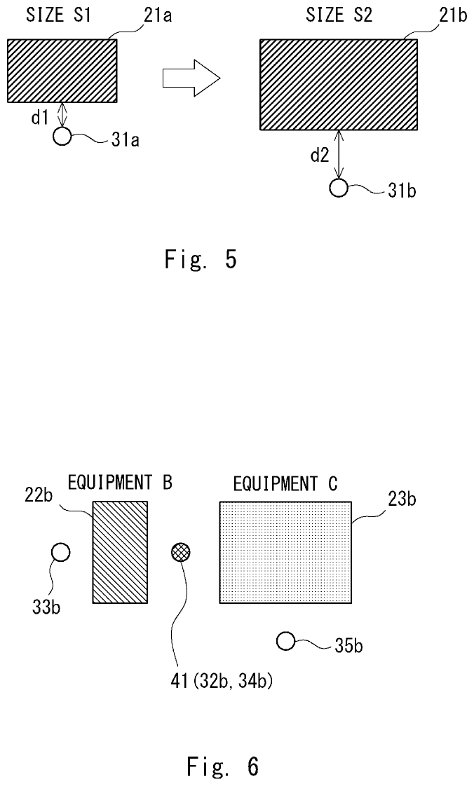

In addition, the measurement position determination unit 12 may correct information regarding the sizes of the pieces of equipment 21a to 24a acquired from the measurement position information storage unit 11 by using the sizes of the pieces of measurement target equipment 21b to 24b actually installed in the facility 20, and correct the measurement positions for the pieces of measurement target equipment 21b to 24b by using the corrected sizes. That is, as illustrated in FIG. 5, even in a case where information regarding a size S1 of the equipment 21a and the measurement position 31a (see the left drawing) is acquired from the measurement position information storage unit 11, the size S1 may be different from a size S2 of the actual measurement target equipment 21b (see the right drawing). In such a case, the size S1 of the equipment 21a acquired from the measurement position information storage unit 11 is corrected by using the size S2 of the measurement target equipment 21b actually installed in the facility 20. Then, the measurement position 31a (measurement distance d1) for the equipment 21a acquired from the measurement position information storage unit 11 may be corrected to the measurement position 31b (measurement distance d2) by using the corrected size.

For example, as illustrated in FIG. 6, in a case where the measurement target equipment 22b and the measurement target equipment 23b are adjacent to each other, the measurement position 32b for the measurement target equipment 22b and the measurement position 34b for the measurement target equipment 23b overlap each other. In such a case, the measurement position determination unit 12 may set a common measurement position 41 between the measurement target equipment 22b and the measurement target equipment 23b. For example, in a case where the measurement range of the measurement device 25 in the horizontal direction is 360 degrees (entire range), the three-dimensional data of the measurement target equipment 22b and the measurement target equipment 23b can be acquired by measuring the entire range at the measurement position 41. Even in a case where the measurement positions for the respective measurement target equipment do not coincide with each other, the measurement position determination unit 12 may set a common measurement position for each measurement target equipment when these measurement positions are adjacent to each other (within a predetermined range).

In the present specification, in order to simplify the description, the shapes of the pieces of equipment 21a to 24a in plan view stored in the measurement position information storage unit 11 illustrated in FIG. 2 are the same as the shapes of the pieces of measurement target equipment 21b to 24b arranged in the facility 20 illustrated in FIG. 4 in plan view. However, in the present example embodiment, when applying the default measurement positions (three-dimensional coordinates) 31a to 37a for the pieces of equipment 21a to 24a stored in the measurement position information storage unit 11 to the measurement target equipment 21b to 24b arranged in the facility 20 illustrated in FIG. 4, the measurement position determination unit 12 needs to convert the measurement positions into a coordinate system of the facility 20.

For example, the measurement positions 31a to 37a for the pieces of equipment 21a to 24a may be converted into the coordinate system of the facility 20 by rotating the pieces of equipment 21a to 24a stored in the measurement position information storage unit 11 illustrated in FIG. 2 in such a way as to correspond to the arrangement of the pieces of measurement target equipment 21b to 24b arranged in the facility 20 illustrated in FIG. 4. Alternatively, the measurement positions 31a to 37a for the pieces of equipment 21a to 24a may be converted into the coordinate system of the facility 20 by fitting the shapes of the pieces of equipment 21a to 24a stored in the measurement position information storage unit 11 illustrated in FIG. 2 to the shapes of the pieces of measurement target equipment 21b to 24b arranged in the facility 20 illustrated in FIG. 4. The measurement positions 31b to 37b for the pieces of measurement target equipment 21b to 24b in the facility 20 can be appropriately determined by converting the coordinate system in this manner.

Next, the patrol route determination unit 13 (see FIG. 1) will be described. The patrol route determination unit 13 determines a patrol route along which the measurement device 25 autonomously moves in the facility 20 and makes a patrol of the pieces of measurement target equipment 21b to 24b by using the information regarding the measurement positions 31b to 37b for the pieces of measurement target equipment 21b to 24b determined by the measurement position determination unit 12.

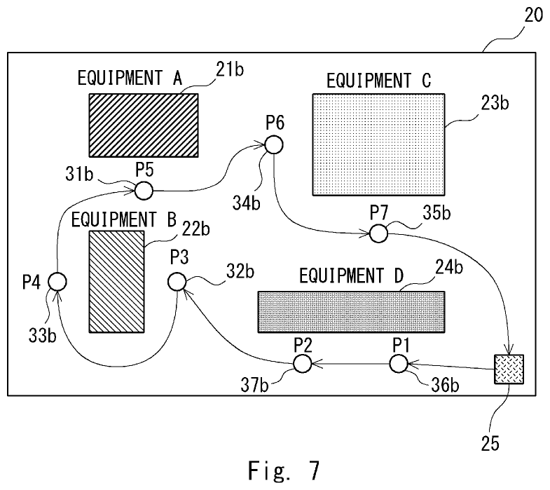

Specifically, the patrol route determination unit 13 determines the patrol route of the measurement device 25 in the facility 20 by connecting the measurement positions 31b to 37b for the pieces of measurement target equipment 21b to 24b determined by the measurement position determination unit 12. FIG. 7 is a diagram for describing patrol route determination processing in the patrol route determination system according to the present example embodiment. As illustrated in FIG. 7, the patrol route determination unit 13 determines patrol routes P1 to P7 of the measurement device 25 in the facility 20 by connecting the measurement positions 31b to 37b for the pieces of measurement target equipment 21b to 24b, respectively. In the example illustrated in FIG. 7, the patrol routes P1 to P7 are determined in such a way as to make a patrol through the measurement positions 36b (P1) and 37b (P2) for the measurement target equipment 24b, the measurement positions 32b (P3) and 33b (P4) for the measurement target equipment 22b, the measurement position 31b (P5) for the measurement target equipment 21b, and the measurement positions 34b (P6) and 35b (P7) for the measurement target equipment 23b in this order.

The patrol route determination unit 13 may determine the patrol routes P1 to P7 in such a way that the measurement device 25 does not collide with the pieces of measurement target equipment 21b to 24b by further using the information regarding the sizes of the pieces of measurement target equipment 21b to 24b provided in the facility 20 and the information regarding the size of the measurement device 25.

For example, the patrol route determination unit 13 may determine the patrol route of the measurement device 25 in the facility 20 by connecting each of the measurement positions 31b to 37b for the pieces of measurement target equipment 21b to 24b determined by the measurement position determination unit 12 in such a way as to form the shortest route.

In addition, a distance that the measurement device 25 can approach may be determined depending on the measurement target equipment. For example, in a case where the pieces of measurement target equipment 21b to 24b are pieces of equipment that deal with a high voltage, it is necessary to increase a distance between the pieces of measurement target equipment 21b to 24b and the measurement device 25 to a predetermined distance. For example, the patrol route determination unit 13 may acquire in advance information regarding an accessible distance to each of the pieces of measurement target equipment 21b to 24b, and determine the patrol route of the measurement device 25 by further using the acquired information regarding the accessible distance.

In addition, the measurement position determination unit 12 may acquire in advance the information regarding the accessible distance to each of the pieces of measurement target equipment 21b to 24b, and correct the sizes of the pieces of measurement target equipment 21b to 24b (for example, increasing the sizes of the pieces of measurement target equipment 21b to 24b) according to the accessible distance to the pieces of measurement target equipment 21b to 24b. The distance between the pieces of measurement target equipment 21b to 24b and the measurement device 25 can be increased to a predetermined distance when the patrol route determination unit 13 determines the patrol route of the measurement device 25 by correcting the sizes of the pieces of measurement target equipment 21b to 24b as described above.

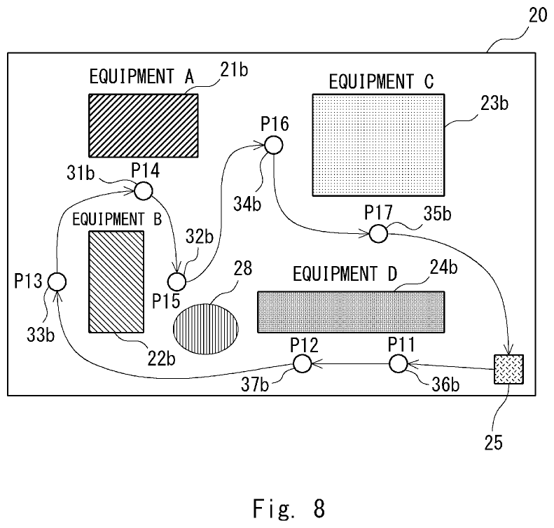

FIG. 8 is a diagram for describing another example of the patrol route determination processing in the patrol route determination system according to the present example embodiment. As illustrated in FIG. 8, for example, in a case where an obstacle 28 is present in the facility 20, the measurement position 37b and the measurement position 32b illustrated in FIG. 7 cannot be connected. In such a case, the patrol route determination unit 13 may acquire information regarding the obstacle 28 in the facility 20 in advance, and determine the patrol route of the measurement device 25 in the facility 20 by further using the acquired information regarding the obstacle 28.

In the example illustrated in FIG. 8, since the obstacle 28 is present between the measurement position 37b and the measurement position 32b, the measurement position 37b and the measurement position 32b cannot be connected. In this case, the patrol route determination unit 13 determines the patrol route in such a way as to connect the measurement position 37b and the measurement position 33b. Specifically, the patrol route determination unit 13 determines patrol routes P11 to P17 in such a way as to make a patrol through the measurement positions 36b (P11) and 37b (P12) for the measurement target equipment 24b, the measurement position 33b (P13) for the measurement target equipment 22b, the measurement position 31b (P14) for the measurement target equipment 21b, the measurement position 32b (P15) for the measurement target equipment 22b, and the measurement positions 34b (P16) and 35b (P17) for the measurement target equipment 23b in this order.

Here, the obstacle is an obstacle derived from the topography in the facility 20 (ground irregularities, trees, ponds, and the like), an obstacle caused by the weather (snow accumulation, puddles, and the like), an object present in the facility 20 (a vehicle, a material, or the like), or the like.

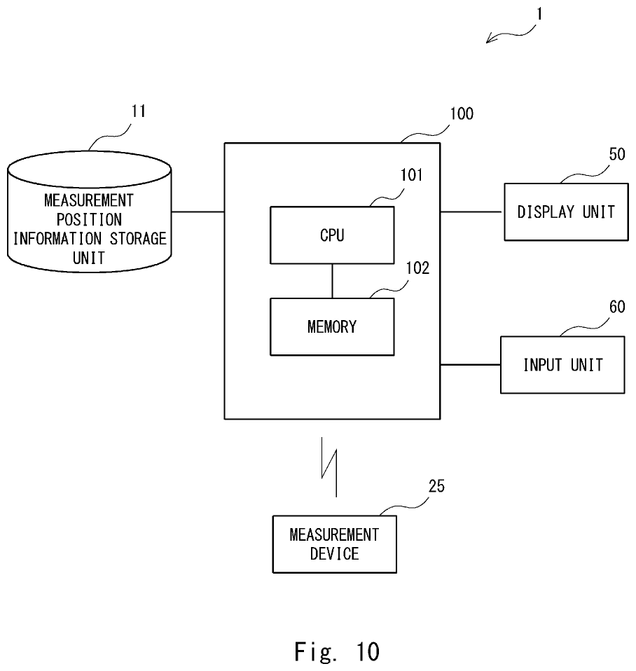

Once the patrol route is determined by the patrol route determination unit 13, the patrol route determination system 1 outputs information regarding the determined patrol route. For example, the information regarding the patrol route may be displayed on a display unit 50 (see FIG. 10). For example, a plan view of the inside of the facility 20 including the pieces of measurement target equipment 21b to 24b, the measurement positions 31b to 37b, and the patrol routes P1 to P7 are displayed on the display unit 50. As the patrol route is displayed on the display unit 50 as described above, a user can visually confirm the patrol route of the measurement device 25.

In a case where the patrol route determination unit 13 cannot determine the patrol route, the patrol route determination system 1 may output an alert. For example, the patrol route determination system 1 may display an alert on the display unit 50 (see FIG. 10). It is possible to request the user to correct the measurement position and the patrol route by displaying the alert on the display unit in this manner. Examples of the case where the patrol route determination unit 13 cannot determine the patrol route include a case where the measurement position of the measurement device 25 overlaps with another measurement target equipment, and a case where the measurement range of the measurement device 25 cannot be set to the measurement range determined by the measurement position determination unit 12.

As described above, in the invention according to the present example embodiment, the information regarding the plurality of pieces of equipment 21a to 24a and the information regarding the measurement positions 31a to 37a where the three-dimensional data of the plurality of pieces of equipment 21a to 24a are to be acquired using the measurement device 25 are stored in the measurement position information storage unit 11 in association with each other (see FIG. 2). The measurement position determination unit 12 determines the measurement positions 31b to 37b where the three-dimensional data of the pieces of measurement target equipment 21b to 24b are to be acquired using the measurement device 25 based on the information regarding the pieces of measurement target equipment 21b to 24b provided in the predetermined facility 20, the information regarding the measurement device 25 used to measure the pieces of measurement target equipment 21b to 24b, and the information regarding the measurement positions 31a to 37a set for the pieces of equipment 21a to 24a stored in the measurement position information storage unit 11 (see FIG. 4). The patrol route determination unit 13 determines the patrol routes P1 to P7 along which the measurement device 25 autonomously moves in the facility 20 and makes a patrol of the pieces of measurement target equipment 21b to 24b by using the information regarding the measurement positions 31b to 37b for the pieces of measurement target equipment 21b to 24b determined by the measurement position determination unit 12 (see FIG. 7).

As described above, in the invention according to the present example embodiment, since it is not necessary to manually set the patrol route of the measurement device, it is possible to suppress complication of work of setting the patrol route. That is, in the invention according to the present example embodiment, it is possible to automatically determine a patrol route along which the measurement device makes a patrol and inspects a predetermined facility.

In the invention according to the present example embodiment, the measurement position information storage unit 11 may store three-dimensional data (for example, point cloud data or CAD data) of the pieces of equipment 21a to 24a as the information regarding the pieces of equipment 21a to 24a. That is, the measurement position information storage unit 11 may store the three-dimensional data (for example, point cloud data or CAD data) of the pieces of equipment 21a to 24a and the information regarding the measurement positions 31a to 37a where the three-dimensional data of the pieces of equipment 21a to 24a are to be newly measured in association with each other.

In this case, the measurement position determination unit 12 acquires the three-dimensional data (for example, point cloud data or CAD data) of the pieces of measurement target equipment 21b to 24b provided in the facility 20 as the information regarding the pieces of measurement target equipment 21b to 24b provided in the facility 20. Then, the measurement position determination unit 12 collates the three-dimensional data of the pieces of equipment 21a to 24a stored in the measurement position information storage unit 11 with the acquired three-dimensional data of the pieces of measurement target equipment 21b to 24b. Thereafter, the measurement position determination unit 12 may determine the measurement positions 31b to 37b for the pieces of measurement target equipment 21b to 24b by using measurement position information for matching equipment among the pieces of information regarding the measurement positions stored in the measurement position information storage unit 11.

For example, the measurement position information storage unit 11 may store feature points of the three-dimensional data of the pieces of equipment 21a to 24a. In this case, the measurement position determination unit 12 extracts feature points from the three-dimensional data of the pieces of measurement target equipment 21b to 24b provided in the facility 20, and compares the extracted feature points with the feature points of the three-dimensional data of the pieces of equipment 21a to 24a stored in the measurement position information storage unit 11. Then, equipment having the most similar shape may be extracted, and a measurement position for the extracted equipment may be used as the measurement position for the measurement target equipment.

In the present example embodiment, the measurement position determination unit 12 may determine a measurement condition of the measurement device 25 for each of the measurement positions 31b to 37b of the pieces of measurement target equipment 21b to 24b. In this case, when the measurement device 25 reaches each of the measurement positions 31b to 37b, the measurement condition of the measurement device 25 may be automatically set to the measurement condition for each of the measurement positions 31b to 37b.

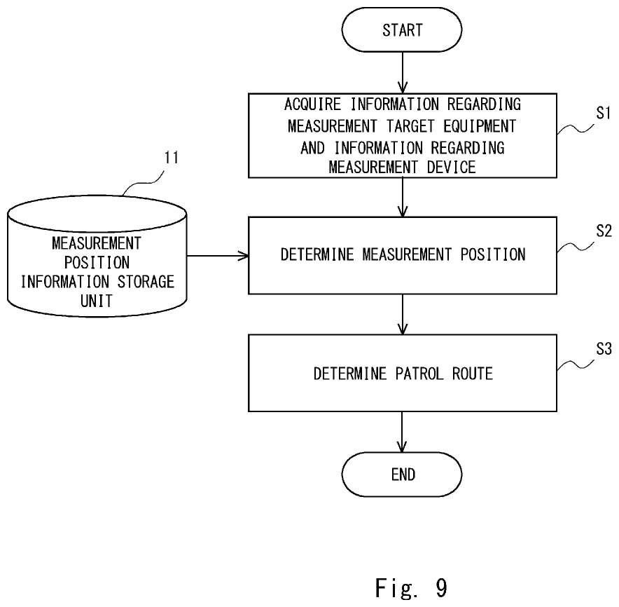

Next, a patrol route determination method according to the present example embodiment will be described. FIG. 9 is a flowchart for describing the patrol route determination method according to the present example embodiment. The measurement position information storage unit 11 illustrated in FIG. 9 corresponds to the measurement position information storage unit 11 illustrated in FIGS. 1 and 2. In the measurement position information storage unit 11, the information regarding the plurality of pieces of equipment 21a to 24a and the information regarding the measurement positions 31a to 37a where the three-dimensional data of the plurality of pieces of equipment are to be acquired using the measurement device 25 are stored in advance in association with each other.

When determining the patrol route, first, the measurement position determination unit 12 acquires the information regarding the pieces of measurement target equipment 21b to 24b provided in the facility 20 and the information regarding the measurement device 25 used to measure the pieces of measurement target equipment 21b to 24b (step S1) (see FIG. 3).

Next, the measurement position determination unit 12 acquires the information regarding the measurement positions 31a to 37a for the pieces of equipment 21a to 24a corresponding to the pieces of measurement target equipment 21b to 24b from the measurement position information storage unit 11. Then, the measurement positions 31b to 37b where the three-dimensional data of the pieces of measurement target equipment 21b to 24b are to be acquired using the measurement device 25 are determined based on the acquired information regarding the measurement positions 31a to 37a and the information regarding the measurement device 25 used to measure the pieces of measurement target equipment 21b to 24b (step S2) (see FIG. 4).

Thereafter, the patrol route determination unit 13 determines a patrol route along which the measurement device 25 autonomously moves in the facility 20 and makes a patrol of the pieces of measurement target equipment 21b to 24b by using the information regarding the measurement positions 31b to 37b for the pieces of measurement target equipment 21b to 24b determined in step S2 (step S3) (see FIG. 7).

Details of the patrol route determination method are similar to the operation of the patrol route determination system described above, and thus, an overlapping description will be omitted.

The present example embodiment can also be implemented by causing a central processing unit (CPU) to execute a computer program.

That is, the present example embodiment can also be implemented by causing a computer to execute a program for the patrol route determination processing including: processing of acquiring information regarding measurement target equipment provided in a predetermined facility and information regarding a measurement device used to measure the measurement target equipment; processing of acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and processing of determining a patrol route along which the measurement device autonomously moves in the facility and makes a patrol of the measurement target equipment by using information regarding the determined measurement position for the measurement target equipment.

FIG. 10 is a block diagram for describing a hardware configuration example including the patrol route determination system according to the present example embodiment. As illustrated in FIG. 10, the patrol route determination system 1 according to the present example embodiment can be configured using an arithmetic processing device 100 including a CPU (101) and a memory 102, and the measurement position information storage unit 11. The measurement position information storage unit 11 can be configured using a storage device such as a hard disk drive (HDD) or a solid state drive (SSD). The measurement position information storage unit 11 stores information regarding a plurality of pieces of equipment and information regarding a measurement position where three-dimensional data of each of the plurality of pieces of equipment is to be acquired using the measurement device in association with each other.

The patrol route determination system 1 (the measurement position determination unit 12 and the patrol route determination unit 13) can be configured by causing the CPU (101) to execute the program for the patrol route determination processing described above. The display unit 50 and an input unit 60 are connected to the arithmetic processing device 100.

The display unit 50 is configured using a liquid crystal display, an organic electro-luminescence (EL) display, or the like. The display unit 50 displays information regarding a patrol route determined by the patrol route determination system 1. For example, a plan view of the inside of the facility 20 including the pieces of measurement target equipment 21b to 24b, the measurement positions 31b to 37b, and the patrol routes P1 to P7 are displayed on the display unit 50 (see FIG. 7).

In addition, the patrol route determination system 1 may display an alert on the display unit 50 in a case where the patrol route cannot be determined. It is possible to request the user to correct the measurement position and the patrol route by displaying the alert on the display unit 50 in this manner. For example, the user may correct the measurement position and the patrol route by operating the input unit 60 (a keyboard, a mouse, or the like).

In addition, the arithmetic processing device 100 (patrol route determination system 1) may be configured to be able to transmit information regarding the patrol route determined in the patrol route determination processing to the measurement device 25. Once the information regarding the patrol route is supplied from the arithmetic processing device 100, the measurement device 25 starts measurement based on the supplied information regarding the patrol route (a patrol route, a measurement condition, a measurement schedule, or the like).

The patrol route determination system 1 (the arithmetic processing device 100 and the measurement position information storage unit 11) may be provided in each facility 20. In addition, the arithmetic processing device 100 (the measurement position determination unit 12 and the patrol route determination unit 13) may be provided in each facility 20, and the measurement position information storage unit 11 may be configured using a cloud server. In this case, the measurement position information storage unit 11 can be shared by a plurality of arithmetic processing devices 100 provided in the respective facilities 20.

Further, the patrol route determination system 1 (the arithmetic processing device 100 and the measurement position information storage unit 11) may be configured as an application server. In a case where the patrol route determination system 1 is configured as an application server, a plurality of users (facilities) can access the patrol route determination system 1 to execute the patrol route determination processing.

In the above-described example embodiment, the program can be stored using various types of non-transitory computer-readable media to be supplied to a computer. The non-transitory computer-readable media include various types of tangible storage media. Examples of the non-transitory computer-readable media include a magnetic recording medium (specifically, a flexible disk, a magnetic tape, or a hard disk drive), a magneto-optical recording medium (specifically, a magneto-optical disc), a compact disc-read only memory (CD-ROM), a CD-R, a CD-R/W, and a semiconductor memory (specifically, a mask ROM, a programmable ROM (PROM), an erasable PROM (EPROM), a flash ROM, or a random access memory (RAM)). In addition, the program may be supplied to the computer by various types of transitory computer-readable media. Examples of the transitory computer-readable media include electrical signals, optical signals, and electromagnetic waves. The transitory computer-readable media can supply the programs to the computer via wired or wireless communication paths such as wires and optical fiber.

Note that the present disclosure is not limited to the above-described example embodiments, and can be appropriately modified without departing from the gist. Furthermore, the present disclosure may be implemented by appropriately combining the respective example embodiments.

Some or all of the above-described example embodiments may be described as the following supplementary notes, but are not limited to the following.

### (Supplementary Note 1)

A patrol route determination system including:
a measurement position information storage unit configured to store information regarding a plurality of pieces of equipment and information regarding a measurement position where three-dimensional data of each of the plurality of pieces of equipment is to be acquired using a measurement device in association with each other;
a measurement position determination unit configured to determine a measurement position where three-dimensional data of measurement target equipment is to be acquired using the measurement device based on information regarding the measurement target equipment provided in a predetermined facility, information regarding the measurement device used to measure the measurement target equipment, and the information regarding the measurement position set for each piece of equipment stored in the measurement position information storage unit; and
a patrol route determination unit configured to determine a patrol route along which the measurement device autonomously moves in the facility and makes a patrol of the measurement target equipment by using information regarding the measurement position for the measurement target equipment determined by the measurement position determination unit.

### (Supplementary Note 2)

The patrol route determination system according to Supplementary Note 1, in which
the information regarding the measurement target equipment provided in the facility includes information regarding a type and an installation position of the measurement target equipment, and
the measurement position determination unit acquires information regarding a measurement position corresponding to the type of the measurement target equipment from the measurement position information storage unit, and determines the measurement position for the measurement target equipment by using the acquired information regarding the measurement position and the information regarding the installation position of the measurement target equipment.

### (Supplementary Note 3)

The patrol route determination system according to Supplementary Note 1 or 2, in which
the information regarding the measurement device used to measure the equipment includes information regarding a measurement range of the measurement device, and
the measurement position determination unit further determines a measurement direction of the measurement device at each measurement position.

### (Supplementary Note 4)

The patrol route determination system according to any one of Supplementary Notes 1 to 3, in which
the information regarding the measurement device used to measure the equipment includes information regarding resolution of the measurement device, and
the measurement position determination unit determines a measurement distance, which is a distance between the measurement device and the measurement target equipment, based on resolution of measurement data to be acquired and the resolution of the measurement device, and determines the measurement position for the measurement target equipment by further using the determined measurement distance.

### (Supplementary Note 5)

The patrol route determination system according to any one of Supplementary Notes 1 to 4, in which
the measurement position information storage unit further stores information regarding a type of the equipment and information regarding a size of the equipment in association with each other, and
the measurement position determination unit determines the measurement position for the measurement target equipment by further using the information regarding the size of the equipment acquired from the measurement position information storage unit.

### (Supplementary Note 6)

The patrol route determination system according to Supplementary Note 5, in which the measurement position determination unit corrects the information regarding the size of the equipment acquired from the measurement position information storage unit by using a size of the measurement target equipment actually installed in the facility, and corrects the measurement position for the measurement target equipment by using the corrected size.

### (Supplementary Note 7)

The patrol route determination system according to any one of Supplementary Notes 1 to 6, in which the patrol route determination unit determines the patrol route of the measurement device in the facility by connecting the measurement position of each piece of measurement target equipment determined by the measurement position determination unit.

### (Supplementary Note 8)

The patrol route determination system according to any one of Supplementary Notes 1 to 7, in which
the information regarding the measurement device used to measure the equipment includes information regarding a size of the measurement device, and
the patrol route determination unit determines the patrol route in such a way that the measurement device does not collide with the measurement target equipment by further using information regarding the size of the measurement target equipment provided in the facility and the information regarding the size of the measurement device.

### (Supplementary Note 9)

The patrol route determination system according to any one of Supplementary Notes 1 to 8, in which the patrol route determination unit acquires information regarding an accessible distance of each piece of measurement target equipment, and determines the patrol route of the measurement device by further using the acquired information regarding the accessible distance of each piece of measurement target equipment.

### (Supplementary Note 10)

The patrol route determination system according to any one of Supplementary Notes 1 to 8, in which
the measurement position determination unit acquires information regarding an accessible distance of each piece of measurement target equipment and corrects the size of the measurement target equipment according to the acquired accessible distance of the measurement target equipment, and
the patrol route determination unit determines the patrol route of the measurement device by using the corrected size of the measurement target equipment.

### (Supplementary Note 11)

The patrol route determination system according to any one of Supplementary Notes 1 to 10, in which the patrol route determination unit acquires information regarding an obstacle present in the facility, and determines the patrol route of the measurement device in the facility by further using the acquired information regarding the obstacle.

### (Supplementary Note 12)

The patrol route determination system according to any one of Supplementary Notes 1 to 11, in which
the measurement position information storage unit stores the three-dimensional data of the equipment as the information regarding the equipment, and stores the three-dimensional data of the equipment and information regarding a measurement position where the three-dimensional data of the equipment is to be newly measured in association with each other, and
the measurement position determination unit acquires the three-dimensional data of the measurement target equipment provided in the facility as the information regarding the measurement target equipment provided in the facility, collates the three-dimensional data of the equipment stored in the measurement position information storage unit with the acquired three-dimensional data of the measurement target equipment, and determines the measurement position for the measurement target equipment by using measurement position information of matching equipment among pieces of information regarding the measurement position stored in the measurement position information storage unit.

### (Supplementary Note 13)

A patrol route determination method including:
acquiring information regarding measurement target equipment provided in a predetermined facility and information regarding a measurement device used to measure the measurement target equipment;
acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and
determining a patrol route along which the measurement device autonomously moves in the facility and makes a patrol of the measurement target equipment by using information regarding the determined measurement position for the measurement target equipment.

### (Supplementary Note 14)

A non-transitory computer-readable medium that stores a program for causing a computer to execute patrol route determination processing including:
processing of acquiring information regarding measurement target equipment provided in a predetermined facility and information regarding a measurement device used to measure the measurement target equipment;
processing of acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and
processing of determining a patrol route along which the measurement device autonomously moves in the facility and makes a patrol of the measurement target equipment by using information regarding the determined measurement position for the measurement target equipment.

### REFERENCE SIGNS LIST

1 PATROL ROUTE DETERMINATION SYSTEM
11 MEASUREMENT POSITION INFORMATION STORAGE UNIT
12 MEASUREMENT POSITION DETERMINATION UNIT
13 PATROL ROUTE DETERMINATION UNIT
21a to 24a EQUIPMENT
21b to 24b MEASUREMENT TARGET EQUIPMENT
25 MEASUREMENT DEVICE
31a to 37a MEASUREMENT POSITION
31b to 37b MEASUREMENT POSITION
P1 to P7, P11 to P17 PATROL ROUTE
50 DISPLAY UNIT
60 INPUT UNIT
100 ARITHMETIC PROCESSING DEVICE
101 CPU
102 MEMORY

What is claimed is:

1. A patrol route determination system comprising:
a measurement position information storage unit configured to store information regarding a plurality of pieces of equipment and information regarding a measurement position where three-dimensional data of each of the plurality of pieces of equipment is to be acquired using a measurement device in association with each other;
a measurement position determination unit configured to determine a measurement position where three-dimensional data of measurement target equipment is to be acquired using the measurement device based on information regarding the measurement target equipment provided in a predetermined facility, information regarding the measurement device used to measure the measurement target equipment, and the information regarding the measurement position set for each piece of equipment stored in the measurement position information storage unit; and
a patrol route determination unit configured to determine a patrol route along which the measurement device autonomously moves in the facility and makes a patrol of the measurement target equipment by using information regarding the measurement position for the measurement target equipment determined by the measurement position determination unit.

2. The patrol route determination system according to claim 1, wherein
the information regarding the measurement target equipment provided in the facility includes information regarding a type and an installation position of the measurement target equipment, and
the measurement position determination unit acquires information regarding a measurement position corresponding to the type of the measurement target equipment from the measurement position information storage unit, and determines the measurement position for the measurement target equipment by using the acquired information regarding the measurement position and the information regarding the installation position of the measurement target equipment.

3. The patrol route determination system according to claim 1, wherein
the information regarding the measurement device used to measure the equipment includes information regarding a measurement range of the measurement device, and
the measurement position determination unit further determines a measurement direction of the measurement device at each measurement position.

4. The patrol route determination system according to claim 1, wherein
the information regarding the measurement device used to measure the equipment includes information regarding resolution of the measurement device, and
the measurement position determination unit determines a measurement distance, which is a distance between the measurement device and the measurement target equipment, based on resolution of measurement data to be acquired and the resolution of the measurement device, and determines the measurement position for the measurement target equipment by further using the determined measurement distance.

5. The patrol route determination system according to claim 1, wherein
the measurement position information storage unit further stores information regarding a type of the equipment and information regarding a size of the equipment in association with each other, and
the measurement position determination unit determines the measurement position for the measurement target equipment by further using the information regarding the size of the equipment acquired from the measurement position information storage unit.

6. The patrol route determination system according to claim 5, wherein the measurement position determination unit corrects the information regarding the size of the equipment acquired from the measurement position information storage unit by using a size of the measurement target equipment actually installed in the facility, and corrects the measurement position for the measurement target equipment by using the corrected size.

7. The patrol route determination system according to claim 1, wherein
the information regarding the measurement device used to measure the equipment includes information regarding a size of the measurement device, and
the patrol route determination unit determines the patrol route in such a way that the measurement device does not collide with the measurement target equipment by further using information regarding the size of the measurement target equipment provided in the facility and the information regarding the size of the measurement device.

8. The patrol route determination system according to claim 1, wherein
the measurement position information storage unit stores the three-dimensional data of the equipment as the information regarding the equipment, and stores the three-dimensional data of the equipment and information regarding a measurement position where the three-dimensional data of the equipment is to be newly measured in association with each other, and
the measurement position determination unit acquires the three-dimensional data of the measurement target equipment provided in the facility as the information regarding the measurement target equipment provided in the facility, collates the three-dimensional data of the equipment stored in the measurement position information storage unit with the acquired three-dimensional data of the measurement target equipment, and determines the measurement position for the measurement target equipment by using measurement position information of matching equipment among pieces of information regarding the measurement position stored in the measurement position information storage unit.

9. A patrol route determination method comprising:
acquiring information regarding measurement target equipment provided in a predetermined facility and information regarding a measurement device used to measure the measurement target equipment;
acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and
determining a patrol route along which the measurement device autonomously moves in the facility and makes a patrol of the measurement target equipment by using information regarding the determined measurement position for the measurement target equipment.

10. A non-transitory computer-readable medium that stores a program for causing a computer to execute patrol route determination processing including:
processing of acquiring information regarding measurement target equipment provided in a predetermined facility and information regarding a measurement device used to measure the measurement target equipment;
processing of acquiring information regarding a measurement position for equipment corresponding to the measurement target equipment from a measurement position information storage unit that stores information regarding a plurality of pieces of equipment and information regarding a measurement position where three-dimensional data of each of the plurality of pieces of equipment is to be acquired using a measurement device in association with each other, and determining a measurement position where three-dimensional data of the measurement target equipment is to be acquired using the measurement device based on the acquired information regarding the measurement position and the information regarding the measurement device used to measure the measurement target equipment; and
processing of determining a patrol route along which the measurement device autonomously moves in the facility and makes a patrol of the measurement target equipment by using information regarding the determined measurement position for the measurement target equipment.

11. The patrol route determination system according to claim 1, wherein the patrol route determination unit determines the patrol route of the measurement device in the facility by connecting the measurement position of each piece of measurement target equipment determined by the measurement position determination unit.

12. The patrol route determination system according to claim 1, wherein the patrol route determination unit acquires information regarding an accessible distance of each piece of measurement target equipment, and determines the patrol route of the measurement device by further using the acquired information regarding the accessible distance of each piece of measurement target equipment.

13. The patrol route determination system according to claim 1, wherein
the measurement position determination unit acquires information regarding an accessible distance of each piece of measurement target equipment and corrects the size of the measurement target equipment according to the acquired accessible distance of the measurement target equipment, and
the patrol route determination unit determines the patrol route of the measurement device by using the corrected size of the measurement target equipment.

14. The patrol route determination system according to claim 1, wherein the patrol route determination unit acquires information regarding an obstacle present in the facility, and determines the patrol route of the measurement device in the facility by further using the acquired information regarding the obstacle.
